(19) United States
(12) Patent Application Publication
(10) Pub. No.: US 2025/0236784 A1
(43) Pub. Date: Jul. 24, 2025

(54) HEAT-ACTIVATED GELLABLE FLUIDS IN ENHANCED HYDROCARBON RECOVERY

(71) Applicant: SAUDI ARABIAN OIL COMPANY, Dhahran (SA)

(72) Inventors: Ziyad Faisal KAIDAR, Qatif (SA); Zuhair ALYOUSEF, Dhahran (SA); Mustafa SATRAWI, Qatif (SA); Muhammad M. ALMAJID, Dhahran (SA); Muhammad ALOTAIBI, Dhahran (SA)

(73) Assignee: SAUDI ARABIAN OIL COMPANY, Dhahran (SA)

(21) Appl. No.: 18/418,047

(22) Filed: Jan. 19, 2024

(51) Int. Cl. C09K 8/588; E21B 43/16

(52) U.S. Cl. CPC C09K 8/588; E21B 43/16

(57) ABSTRACT

Gellable fluids may be used in enhanced hydrocarbon recovery operations. Methods to promote gelling of gellable fluids may comprise: introducing a gellable fluid to a subterranean reservoir, the gellable fluid including a gellable starch dispersed in an aqueous fluid; introducing a first salt and a second salt into the subterranean reservoir, the first salt being capable of undergoing an exothermic reaction with the second salt; contacting the first salt with the second salt in the subterranean reservoir under conditions where the first salt and the second salt undergo the exothermic reaction; and heating the gellable fluid with heat produced from the exothermic reaction to form a gelled fluid comprising a gelled starch and having an increased viscosity.

### FIELD OF THE DISCLOSURE

The present disclosure relates generally to hydrocarbon production and, more particularly, to enhanced hydrocarbon recovery to promote hydrocarbon production.

### BACKGROUND OF THE DISCLOSURE

Enhanced hydrocarbon recovery (e.g., enhanced oil recovery, EOR) refers to methods and systems that inject fluids through an injection well to a downhole location to perform functions that facilitate the release of the hydrocarbons within a subterranean reservoir and mobilization of the hydrocarbons toward a production well. Oftentimes, enhanced hydrocarbon recovery may be employed in subterranean reservoirs where conventional techniques have yielded limited production, such as in shale formations and other tight reservoirs, for example.

The injected fluids may promote release and mobilization of hydrocarbons through a variety of mechanisms including oil swelling, viscosity reduction, and wettability alteration, for example. The manner in which enhanced hydrocarbon recovery operations are conducted under particular circumstances may depend on factors including, for example, the geology of the formation and/or the type of hydrocarbons being produced. In some cases, high-permeability zones may be present that may preclude a subterranean reservoir from undergoing effective hydrocarbon mobilization.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Non-limiting example methods of the present disclosure may comprise: introducing a gellable fluid to a subterranean reservoir, the gellable fluid comprising a gellable starch dispersed in an aqueous fluid; introducing a first salt and a second salt into the subterranean reservoir, the first salt being capable of undergoing an exothermic reaction with the second salt; contacting the first salt with the second salt in the subterranean reservoir under conditions where the first salt and the second salt undergo the exothermic reaction; and heating the gellable fluid with heat produced from the exothermic reaction to form a gelled fluid comprising a gelled starch and having an increased viscosity.

Some or other non-limiting example methods of the present disclosure may comprise: introducing a gellable fluid to a subterranean reservoir, the gellable fluid comprising Cycas revoluta starch dispersed in an aqueous fluid; introducing a first salt and a second salt into the subterranean reservoir, the first salt being capable of undergoing an exothermic reaction with the second salt; wherein the subterranean reservoir has a temperature insufficient to initiate the exothermic reaction between the first salt and the second salt; introducing an acid into the subterranean reservoir to initiate the exothermic reaction; contacting the first salt with the second salt in the subterranean reservoir in the presence of the acid to initiate the exothermic reaction; and heating the gellable fluid with heat produced from the exothermic reaction to form a gelled fluid comprising a gelled starch and having an increased viscosity.

Still other non-limiting example methods of the present disclosure may comprise: introducing a gellable fluid to a subterranean reservoir, the gellable fluid comprising Cycas revoluta starch dispersed in an aqueous fluid; introducing a first salt solution comprising a first salt and a second salt solution comprising a second salt into the subterranean reservoir, the first salt being capable of undergoing an exothermic reaction with the second salt; contacting the first salt solution with the second salt solution in the subterranean reservoir under conditions where the first salt and the second salt undergo the exothermic reaction; and heating the gellable fluid with heat produced from the exothermic reaction to form a gelled fluid comprising a gelled starch and having an increased viscosity.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example graph showing the temperature increase occurring during an exothermic reaction of sodium nitrite and ammonium chloride.

FIG. 2 is a diagram showing the effects of an exothermic reaction in producing a gelled fluid within a blocking zone of a subterranean reservoir.

FIG. 3 is a graph of initial viscosity versus temperature for Samples 1A-1C.

FIG. 4 is a graph of viscosity versus time for Sample 1D.

### DETAILED DESCRIPTION

The present disclosure relates generally to hydrocarbon production and, more particularly, to enhanced hydrocarbon recovery to promote hydrocarbon production.

The present disclosure provides compositions and methods for treatment of a subterranean reservoir through occlusion of one or more blocking zones within fractures of the subterranean reservoir using a gellable fluid. The gellable fluid may include a biological gel, such as a starch-based gel (gellable starch). In an example, a suitable starch-based gel may be obtained from, for example, sago palm (Cycas revoluta) starch. The starch-based gel may undergo gelation upon heating to a sufficient temperature, and the resulting gel may promote occlusion of the one or more blocking zones within the subterranean reservoir. By occluding the one or more blocking zones, an aqueous flooding fluid may be utilized more effectively to promote hydrocarbon mobilization during enhanced hydrocarbon recovery. Fluid diversion may also be advantageous in other situations as well, such as for conducting localized acidizing or consolidation, for example.

The present disclosure includes methods wherein the gellable fluid undergoes viscosification as a result of an exothermic reaction between a first salt and a second salt within the subterranean reservoir. Heat generated from the exothermic reaction may result in viscosification of the gellable starch and increase viscosity of the gellable fluid to produce a gelled fluid containing gelled starch. As a result of the increased viscosity, fluid diversion may be realized within the subterranean reservoir to facilitate increased production of hydrocarbons through suitable means such as, for example, aqueous flooding during enhanced hydrocarbon recovery or while conducting various stimulation operations.

Blocking zone(s) may refer to any portion(s) of a subterranean reservoir wherein it is desired to place a gellable fluid for subsequent viscosification to limit fluid loss and/or to preclude flow of an unwanted fluid therefrom (e.g., formation water). As a nonlimiting example, a blocking zone may comprise a high-permeability zone in a subterranean reservoir, from which it is desired to limit fluid loss to promote enhanced hydrocarbon recovery elsewhere in the subterranean reservoir.

In any embodiment of the present disclosure, a gellable fluid containing a gellable starch may be introduced to one or more blocking zones of a subterranean reservoir. The manner in which the gellable fluid is introduced to the subterranean reservoir and the one or more blocking zones is not believed to be especially limited. The first salt and the second salt undergoing the exothermic reaction to promote gelation may be introduced within the gellable fluid or separately in one or more salt solutions, depending on conditions within the subterranean reservoir and how one chooses to initiate the exothermic reaction. In some examples, at least one of the first salt or the second salt may be introduced to the subterranean reservoir within the gellable fluid. In other examples, the first salt and the second salt may be introduced as a first salt solution and a second salt solution, respectively, wherein said first salt solution and second salt solution are separate from each other and/or the gellable fluid. In some cases, it is even possible for the first salt and the second salt to be introduced to the subterranean reservoir together in a combined salt solution, provided that the temperature of the subterranean reservoir is sufficiently low to preclude a spontaneous reaction of the first salt and the second salt prior to reaching a desired location proximate to the gellable fluid. When the subterranean reservoir has a temperature insufficient to initiate the exothermic reaction, the first salt and the second salt may be activated with an acid to initiate the exothermic reaction and produce heat.

The first salt and second salt may comprise any suitable combination of salts that may undergo an exothermic reaction under specified conditions upon being combined together and activated within the subterranean reservoir. In more specific examples, the first salt may comprise a nitrite salt, such as sodium nitrite or other alkali metal nitrite, and the second salt may comprise an ammonium salt, such as ammonium chloride or other ammonium halide. The first salt and the second salt may each be delivered to the subterranean reservoir as part of one or more salt-containing solutions in any combination (e.g., a combined salt solution, a first salt solution containing the first salt, a second salt solution containing the second salt, the gellable fluid, or any suitable combination thereof). Salt-containing solutions of the present disclosure may each have a salt concentration sufficient to undergo an exothermic reaction generating a desired amount of heat when the first salt and the second salt are sufficiently activated upon contacting one another. For example, salt concentrations within the salt-containing solutions may each range from about 1 M (mol/L) to about 10 M, or about 3 M to about 6 M, or about 4 M to about 6 M, or about 2 M to about 7 M, or about 1 M to about 8 M, or about 1 M to about 10 M, or even greater than 10 M. The concentrations of the first and second salts may each reside within the foregoing ranges. The concentrations of salt-containing solution(s) of the present disclosure may be the same or may differ. For example, a concentration of first salt (e.g., sodium nitrite) in a first salt solution may be different than a concentration of second salt (e.g., ammonium chloride) in a second salt solution. Similarly, the volume of salt-containing solution(s) introduced to the subterranean reservoir may be the same or differ. By varying the concentration and amounts of the salt-containing solutions introduced to the subterranean reservoir, the amount of heat released during the exothermic reaction may be varied. The first salt and the second salt may be introduced to the subterranean reservoir in salt-containing solutions under similar conditions to one another, as well as under conditions similar to those at which the gellable fluid is introduced to the subterranean reservoir, though conditions may vary.

Gellable fluids of the present disclosure may include a biological gel, such as a gellable polysaccharide, preferably a gellable starch and an aqueous fluid. The gellable starch may be present in the aqueous fluid in concentrations ranging from about 0.05 wt % to about 5.0 wt %, or about 0.1 wt % to about 3.0 wt %, or about 0.1 wt % to about 2.5 wt %, or about 0.1 wt % to about 1.0 wt %, or about 1.0 wt % to about 2.5 wt %, based on the total weight of the gellable fluid.

Any suitable gellable polysaccharide may be used in methods of the present disclosure. Examples of suitable gellable polysaccharides may be derived from sources including, but not limited to sago palm (Cycas revoluta) starch, xanthan gum, guar gum, agar agar, tapioca starch, hydroxyethyl cellulose, diutan gum, welan gum, the like, or any combination thereof.

Any suitable aqueous fluid may be used as a carrier fluid in gellable fluids of the present disclosure, provided that the aqueous fluid does not interfere with functions of the gellable fluid. Example of suitable aqueous fluids may include, but are not limited to, fresh water (e.g., stream water, lake water, or municipal treated water), non-potable water such as gray water or industrial process water, sea water, brine, aqueous salt solutions, partially desalinated water, produced water (including brine and other saltwater solutions), the like, or any combination thereof. Brine may be a preferred aqueous fluid for delivery of the first and second salts to the subterranean reservoir.

Once in the subterranean reservoir, the first salt and the second salt may contact each other within the blocking zone in the presence of, or in proximity to, the gellable fluid so that the first and second salts undergo the exothermic reaction under specified conditions. In the case of sodium nitrite and ammonium chloride, the exothermic reaction occurs as shown in Reaction 1 below:

NaNO₂+NH₄Cl→NaCl+H₂O+N₂ Reaction 1

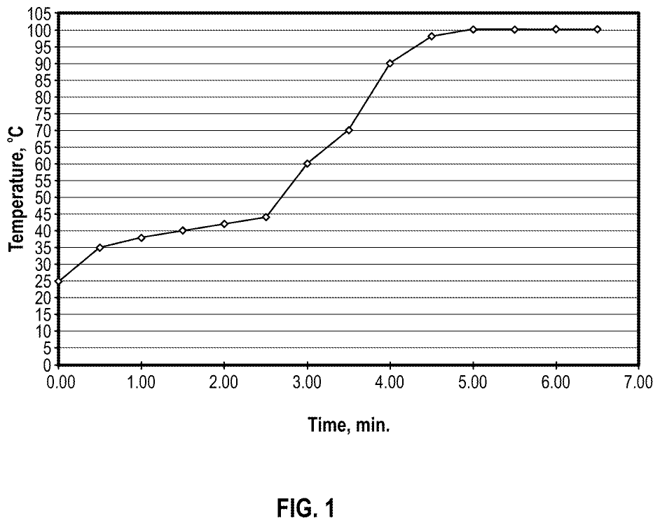

The term “exothermic” and grammatical variants thereof refer to a chemical reaction which generates thermal energy (e.g., heat) and may be defined as a reaction having an enthalpy of reaction (ΔH) less than zero. In the case of the exothermic reaction between sodium nitrite and ammonium chloride, the standard enthalpy of reaction is −79.95 kcal mol⁻¹. FIG. 1 is an example graph showing the temperature increase occurring during an exothermic reaction of sodium nitrite and ammonium chloride. The reaction is promoted using acetic acid as a catalyst. As shown, after starting from room temperature (25° C.), the temperature slowly increased to 45° C. over about 2.5 minutes before rapidly increasing to about 100° C. and stabilizing at this temperature within about 5 minutes of total reaction.

The exothermic reaction may occur at a specified temperature, preferably a temperature greater than about 60° C., or greater than about 70° C., or from about 50° C. to about 70° C. or from about 70° C. to about 100° C., for example. Heating of salt-containing solutions including the first salt and/or the second salt may take place using the latent heat present within the subterranean reservoir to initiate the exothermic reaction. Alternately, at least one of the solutions (e.g., the first salt solution, the second salt solution, the gellable fluid, the like, or any combination thereof) may be heated prior to or concurrently with introduction to the subterranean reservoir.

Alternately or additionally, the exothermic reaction may be catalyzed by an acid, such as at a pH of about 5 or less. An acid may be introduced into the gellable fluid or be present in one of the salt solutions in a sufficient amount to catalyze the exothermic reaction. When the first salt contains a nitrite anion and the second salt contains an ammonium cation, the acid may be introduced to the second salt solution containing the ammonium cation. Nitrite anions may be unstable to acid and form nitrous acid in the presence of a sufficiently strong acid. Hence, nitrite ions may preferably be kept separate from the acid until the acid is needed to promote the exothermic reaction according to the disclosure herein. Alternately, the acid may be introduced to the blocking zone of the subterranean reservoir as a neat acid or an acid solution introduced to the subterranean reservoir separately from the other solution(s). The acid may be an inorganic acid (e.g., hydrochloric acid or hydrobromic acid), an organic acid, or any suitable combination thereof. Preferably, the acid may be an organic acid such as formic acid, acetic acid, propionic acid, methanesulfonic acid, chloroacetic acid, trifluoroacetic acid, the like, or any combination thereof.

To limit the possibility of the exothermic reaction taking place before reaching the blocking zone or another intended location within the subterranean reservoir, salt-containing solutions may be introduced to the subterranean reservoir separately as a first salt solution and a second salt solution. For example, separate pipes (lines) may carry the first salt solution and second salt solution to a desired location in the subterranean reservoir for undergoing an exothermic reaction to provide heat to the gellable fluid to promote gelation. In another example, one of the salt solutions may be introduced to the subterranean reservoir via coiled tubing within the subterranean reservoir, and the other of the salt solutions may be carried within an annulus between the coiled tubing and the well casing. It is also envisioned that one or both of the first salt and the second salt may alternately be present in the gellable fluid prior to introduction of the gellable fluid into the subterranean reservoir, in which case additional salt may be introduced as a separate salt solution (e.g., a second salt solution). The first salt and the second salt may be suitably present in the same solution when the subterranean reservoir has a sufficiently low temperature to preclude a spontaneous exothermic reaction within the subterranean reservoir. When the subterranean reservoir has a sufficiently low temperature, the exothermic reaction may be initiated with acid, as referenced above.

Methods of the present disclosure may be conducted in subterranean reservoirs that have a sufficient temperature to initiate the exothermic reaction between the first salt and the second salt, such as a temperature of at least about 50° C. or greater, or about 60° C. or greater in the case of a nitrite salt and an ammonium salt. Such methods may comprise: introducing a gellable fluid to a subterranean reservoir, the gellable fluid comprising a gellable starch (e.g., Cycas revoluta starch) dispersed in an aqueous fluid; introducing a first salt and a second salt (e.g., in a first salt solution and a second salt solution, respectively) into the subterranean reservoir, the first salt being capable of undergoing an exothermic reaction with the second salt; contacting the first salt with the second salt in the subterranean reservoir under conditions where the first salt and the second salt undergo the exothermic reaction; and heating the gellable fluid with heat produced from the exothermic reaction to form a gelled fluid comprising a gelled starch and having an increased viscosity.

In other instances, the subterranean reservoir may have a temperature insufficient to initiate the exothermic reaction, in which case an acid may be introduced to the subterranean reservoir in at least one of a first salt solution or a second salt solution to catalyze the exothermic reaction. Alternately, an acid may be introduced as an acid solution to the subterranean reservoir separately from the first salt solution and the second salt solution. Further alternately, an acid may be introduced to the subterranean reservoir in the gellable fluid. As a non-limiting example, such methods may comprise: introducing a gellable fluid to a subterranean reservoir, the gellable fluid comprising a gellable starch (e.g., Cycas revoluta starch) dispersed in an aqueous fluid; introducing a first salt and a second salt into the subterranean reservoir, the first salt being capable of undergoing an exothermic reaction with the second salt; introducing an acid into the subterranean reservoir to initiate the exothermic reaction; contacting the first salt with the second salt in the subterranean reservoir in the presence of the acid to initiate the exothermic reaction; and heating the gellable fluid with heat produced from the exothermic reaction to form a gelled fluid comprising a gelled starch and having an increased viscosity.

It should be noted that an acid may be introduced to the subterranean reservoir to further promote the exothermic reaction, even when the subterranean reservoir already has a temperature sufficient to initiate the exothermic reaction between the first salt and the second salt.

Upon heating the gellable fluid in the subterranean reservoir as a consequence of the exothermic reaction, the viscosity may increase by factors including, but not limited to, by about 1% to about 300%, or about 1% to about 200%, or about 50% to about 300%, or about 100% or greater, or about 300% or greater, or greater than about 300%, each as measured based upon the viscosity of the gelled fluid relative to the gellable fluid initially being introduced to the subterranean reservoir. The initial viscosity of the gellable fluid may be, for example, from about 0.1 cP to about 100 cP, or about 0.1 cP to about 25 cP, or about 0.1 cP to about 10 cP. The final viscosity of the gelled fluid after heating as a consequence of the exothermic reaction may be, for example, from about 0.1 cP to about 100 cP, or about 10 cP to about 25 cP, or about 0.1 cP to about 10 cP. Values outside the aforementioned ranges of initial and final viscosities are additionally contemplated.

The methods of the present disclosure may utilize additional fluids and/or include components to carry out a desired enhanced hydrocarbon recovery operation. Such additional fluids may be introduced to the subterranean reservoir after an optional waiting period following the exothermic reaction to promote viscosification of the gellable fluid. The waiting period may be selected to be sufficient for a desired viscosity to be reached and/or for a desired temperature to be reached in order for one or more aspects of an enhanced hydrocarbon recovery operation to take place. Examples of waiting period durations may include, but are not limited to, about 1 hour or less, about 1 hour or greater, or about 6 hours or greater, or about 12 hours or greater, or about 24 hours or greater, or about 48 hours or greater, such as about 1 hour to about 48 hours, or about 1 hour to about 72 hours, or about 6 hours to about 12 hours, or about 8 hours to about 24 hours. The duration of the waiting period may be affected by factors including, for example, the geology of the subterranean reservoir, the initial viscosity of the gellable fluid, the concentrations and amounts of the first and second salts within the salt solution(s), the presence and amount of an acid, the like, or any combination thereof. Following the waiting period (if any), additional fluids may be introduced to the subterranean reservoir, such as, but not limited to, an aqueous flooding fluid for enhanced hydrocarbon recovery, a fracturing fluid, an acidizing fluid, a consolidation fluid, the like, or any combination thereof. As a non-limiting example, an aqueous flooding fluid may be introduced to the subterranean reservoir following viscosification of the gellable fluid under promotion of the exothermic reaction. The additional fluid (e.g., an aqueous flooding fluid) may subsequently promote mobilization of hydrocarbons within the subterranean reservoir and/or facilitate further production of the hydrocarbons from a production well. The viscosified fluid may divert an aqueous flooding fluid to a portion of the subterranean formation from which the aqueous flooding fluid may more effectively promote hydrocarbon mobilization, for example.

Furthermore, fluids (e.g., solutions, aqueous flooding fluids, and the like) of the present disclosure may further include one or more additional components suitable for achieving one or more desired functions (e.g., in addition to facilitating occlusion of the one or more blocking zones, or promoting hydrocarbon mobilization). Examples of suitable additional components may include, but are not limited to, a salt, a weighting agent, an inert solid, a fluid loss control agent, an emulsifier, a dispersion aid, a corrosion inhibitor, an emulsion thinner, an emulsion thickener, a viscosifying agent, a gelling agent, a particulate, a lost circulation material, a foaming agent, a gas, a pH control additive, a breaker, a biocide, a crosslinker, a chelating agent, a scale inhibitor, a gas hydrate inhibitor, a mutual solvent, an oxidizer, a reducer, a friction reducer, an iron control agent, the like, or any combination thereof. Suitable examples of the foregoing will be familiar to one having ordinary skill in the art.

Any of the fluids discussed herein may be mixed at a remote location from a job site and shipped thereto or may be mixed at a job site. In still other examples, mixing of the fluid(s) may take place on-the-fly as the fluid is pumped into a subterranean reservoir. A person having ordinary skill in the art and the benefit of this disclosure will be able to consider these factors and determine whether remote mixing, on-site mixing, or any other suitable mixing protocol is most appropriate for a given operation.

Systems for introducing the fluids of the present disclosure into a subterranean reservoir may include one or more mixing and/or storage tanks for mixing and/or storing the fluids prior to their introduction to a subterranean reservoir. Additional tanks may be used for storing spent or partially spent fluids removed from a subterranean reservoir.

Systems for introducing the fluids to a wellbore in conjunction with an enhanced hydrocarbon recovery operation may comprise a pump fluidly coupled to a tubing extended into a wellbore penetrating the subterranean reservoir. The pump may comprise a single pump or may comprise multiple pumps. Given the benefit of the present disclosure, one having ordinary skill in the art will be able to select appropriate system component(s) (e.g., including a pump or combination of pumps) for a given application.

Additional nonlimiting components may be present in systems suitable to introduce and produce fluids according to the present disclosure will be familiar to persons having ordinary skill in the art and may include, for example, supply hoppers, valves, condensers, adapters, joints, gauges, sensors, compressors, pressure controllers, pressure sensors, flow rate controllers, flow rate sensors, temperature sensors, the like, or any combination thereof.

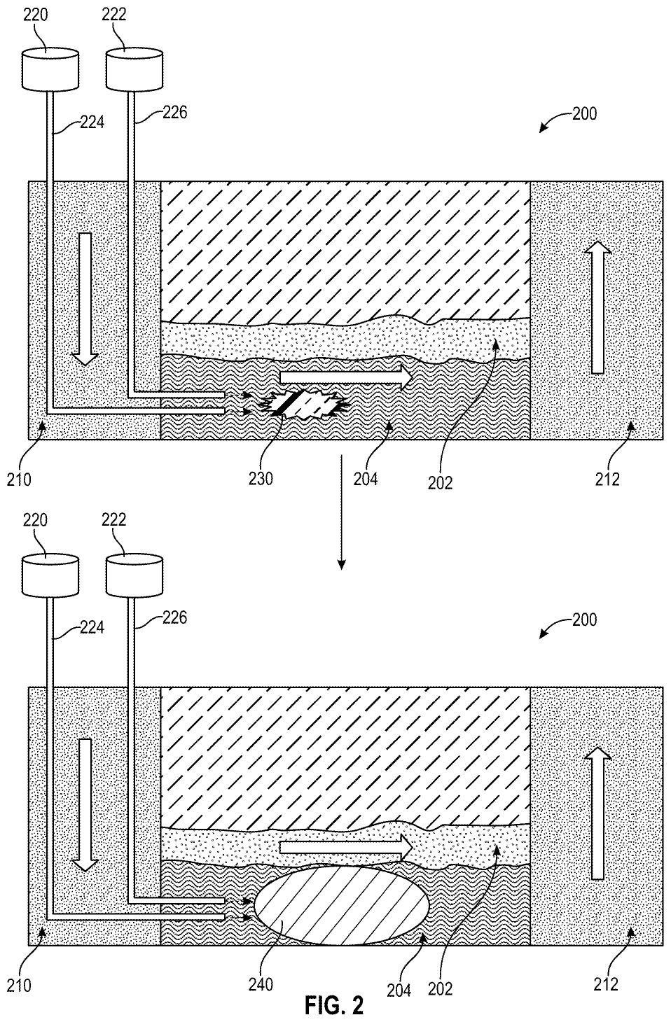

Aspects of the present disclosure are now further described in reference to FIG. 2. FIG. 2 is a diagram showing the effects of an exothermic reaction in producing a gelled fluid within a blocking zone of a subterranean reservoir. As shown, subterranean reservoir 200 includes pay zone 202 and blocking zone 204. Injection well region 210, through which an aqueous flooding fluid may be introduced, penetrates subterranean reservoir 200. The aqueous flooding fluid may mobilize hydrocarbons within pay zone 202 for recovery from production well region 212. The general direction of fluid flow in subterranean reservoir 200 is indicated by block arrows. Blocking zone 204 may represent any portion of subterranean reservoir through which unwanted fluid loss may occur, such as loss of the aqueous flooding fluid to result in ineffective mobilization of hydrocarbons from pay zone 202.

Tanks 220 and 222 contain first and second salt solutions, respectively, and deliver the first and second salt solutions to blocking zone 204 or proximal to blocking zone 204 via lines 224 and 226. Injection well region 210 may likewise be utilized to deliver a gellable fluid to blocking zone 204, either separately or within one of the first or second salt solutions. As described herein, the gellable fluid may contain a gellable starch. With the gellable fluid in place in blocking zone 204, the first and second salts may undergo an exothermic reaction to release heat 230 upon contacting one another under suitable conditions in or near blocking zone 204. Heat 230 may promote viscosification of the gellable fluid to produce gelled fluid 240 within blocking zone 204. With gelled fluid 240 in place in blocking zone 204, a subsequently introduced aqueous flooding fluid may be diverted to pay zone 202 to promote hydrocarbon mobilization to production well region 212.

Embodiments disclosed herein include:

A. Methods for producing a gelled fluid. The methods comprise: introducing a gellable fluid to a subterranean reservoir, the gellable fluid comprising a gellable starch dispersed in an aqueous fluid; introducing a first salt and a second salt into the subterranean reservoir, the first salt being capable of undergoing an exothermic reaction with the second salt; contacting the first salt with the second salt in the subterranean reservoir under conditions where the first salt and the second salt undergo the exothermic reaction; and heating the gellable fluid with heat produced from the exothermic reaction to form a gelled fluid comprising a gelled starch and having an increased viscosity.

B. Methods for producing a gelled fluid. The methods comprise: introducing a gellable fluid to a subterranean reservoir, the gellable fluid comprising Cycas revoluta starch dispersed in an aqueous fluid; introducing a first salt and a second salt into the subterranean reservoir, the first salt being capable of undergoing an exothermic reaction with the second salt; wherein the subterranean reservoir has a temperature insufficient to initiate the exothermic reaction between the first salt and the second salt; introducing an acid into the subterranean reservoir to initiate the exothermic reaction; contacting the first salt with the second salt in the subterranean reservoir in the presence of the acid to initiate the exothermic reaction; and heating the gellable fluid with heat produced from the exothermic reaction to form a gelled fluid comprising a gelled starch and having an increased viscosity.

C. Methods for producing a gelled fluid. The methods comprise: introducing a gellable fluid to a subterranean reservoir, the gellable fluid comprising Cycas revoluta starch dispersed in an aqueous fluid; introducing a first salt solution comprising a first salt and a second salt solution comprising a second salt into the subterranean reservoir, the first salt being capable of undergoing an exothermic reaction with the second salt; contacting the first salt solution with the second salt solution in the subterranean reservoir under conditions where the first salt and the second salt undergo the exothermic reaction; and heating the gellable fluid with heat produced from the exothermic reaction to form a gelled fluid comprising a gelled starch and having an increased viscosity.

Each of embodiments A through C may have one or more of the following additional elements in any combination:

Element 1: wherein the gellable fluid is introduced to at least one blocking zone of the subterranean reservoir.

Element 2: wherein the first salt is introduced to the subterranean reservoir in a first salt solution and the second salt is introduced to the subterranean reservoir in a second salt solution, the first salt solution and the second salt solution being kept separate from one another prior to contacting the first salt with the second salt in the subterranean reservoir.

Element 3: wherein the first salt is introduced to the subterranean reservoir within the gellable fluid and the second salt is introduced to the subterranean reservoir in a second salt solution, the gellable fluid and the second salt solution being kept separate from one another prior to contacting the first salt with the second salt in the subterranean reservoir.

Element 4: wherein the subterranean reservoir has a temperature sufficient to initiate the exothermic reaction, an acid is introduced to the subterranean reservoir to initiate the exothermic reaction, or any combination thereof.

Element 5: wherein the acid is introduced to the subterranean reservoir to initiate the exothermic reaction, and the acid comprises an organic acid.

Element 6: wherein the acid is introduced to the subterranean reservoir to initiate the exothermic reaction, and the acid is present in at least one of a first salt solution containing the first salt, a second salt solution containing the second salt, or any combination thereof.

Element 7: wherein the exothermic reaction occurs at a temperature of about 60° C. or greater, at a pH of about 5 or less, or any combination thereof.

Element 8: wherein the first salt comprises a nitrite anion and the second salt comprises an ammonium cation, the nitrite anion and the ammonium cation undergoing the exothermic reaction once the first salt and the second salt are contacted with one another in the subterranean reservoir.

Element 9: wherein the first salt comprises an alkali metal nitrite and the second salt comprises an ammonium halide.

Element 10: wherein first salt comprises sodium nitrite and the second salt comprises ammonium chloride.

Element 11: wherein the gellable fluid has a viscosity of about 0.1 cP to about 10 cP prior to heating.

Element 12: wherein the gelled fluid has a viscosity of about 10 cP to about 25 cP after heating.

Element 13: wherein the heating to form the gelled fluid increases the viscosity of the gelled fluid by about 100% or more relative to the gellable fluid.

Element 14: wherein the method further comprises: introducing an aqueous flooding fluid into the subterranean reservoir after heating the gellable fluid to form the gelled fluid, wherein the gelled fluid diverts the aqueous flooding fluid away from at least one blocking zone within the subterranean reservoir.

Element 15: wherein the at least one blocking zone comprises a high permeability zone within the subterranean reservoir.

Element 16: wherein the method further comprises: producing hydrocarbons from the subterranean reservoir.

Element 17: wherein the gellable starch has a concentration of about 0.1 wt % to about 2.5 wt % in the gellable fluid.

Element 18: wherein the gellable starch comprises Cycas revoluta starch.

Element 19: wherein the acid is present in at least one of a first solution containing the first salt, a second solution containing the second salt, or any combination thereof.

Element 20: wherein the first salt and the second salt are present in a first solution, and the acid is present in a second solution introduced to the subterranean reservoir separately from the first solution.

Element 21: wherein the first salt comprises a nitrite anion and the second salt comprises an ammonium cation, the nitrite anion and the ammonium cation undergoing the exothermic reaction once the first salt and the second salt are contacted with one another in the subterranean reservoir.

Element 22: wherein the first salt solution and the second salt solution are kept separate from one another prior to contacting the first salt solution with the second salt solution in the subterranean reservoir.

By way of nonlimiting example, exemplary combinations applicable to A through C include, but are not limited to: 7 and 8; 7 and 9; 9 and 10; 1 and 12; 12 and 13; 9-10 and 17; 14 and 15; 14-16; 9 and 17; and 1516. Additional exemplary combinations applicable to A include, but are not limited to: 1 and 2; 1 and 3; 1 and 4; 1 and 17-18, 9-10 and 17-18; 4 and 19; 4 and 5; 4 and 6; 4-6; 4-7; 4 and 7; 5 and 6; 1 and 7. Additional exemplary combinations applicable to B include, but are not limited to: 19 and 21; 20 and 21; and 19-21. Additional exemplary combinations applicable to C include, but are not limited to: 8 and 22; and 8 and 23.

Additional embodiments disclosed herein include:

Clause 1. A method comprising: introducing a gellable fluid to a subterranean reservoir, the gellable fluid comprising a gellable starch dispersed in an aqueous fluid; introducing a first salt and a second salt into the subterranean reservoir, the first salt being capable of undergoing an exothermic reaction with the second salt; contacting the first salt with the second salt in the subterranean reservoir under conditions where the first salt and the second salt undergo the exothermic reaction; and heating the gellable fluid with heat produced from the exothermic reaction to form a gelled fluid comprising a gelled starch and having an increased viscosity.

Clause 2. The method of clause 1, wherein the gellable fluid is introduced to at least one blocking zone of the subterranean reservoir.

Clause 3. The method of clause 1 or clause 2, wherein the first salt is introduced to the subterranean reservoir in a first salt solution and the second salt is introduced to the subterranean reservoir in a second salt solution, the first salt solution and the second salt solution being kept separate from one another prior to contacting the first salt with the second salt in the subterranean reservoir.

Clause 4. The method of clause 1 or clause 2, wherein the first salt is introduced to the subterranean reservoir within the gellable fluid and the second salt is introduced to the subterranean reservoir in a second salt solution, the gellable fluid and the second salt solution being kept separate from one another prior to contacting the first salt with the second salt in the subterranean reservoir.

Clause 5. The method of any one of clauses 1-4, wherein the subterranean reservoir has a temperature sufficient to initiate the exothermic reaction, an acid is introduced to the subterranean reservoir to initiate the exothermic reaction, or any combination thereof.

Clause 6. The method of clause 5, wherein the acid is introduced to the subterranean reservoir to initiate the exothermic reaction, and the acid comprises an organic acid.

Clause 7. The method of clause 5, wherein the acid is introduced to the subterranean reservoir to initiate the exothermic reaction, and the acid is present at least one of a first salt solution containing the first salt, a second salt solution containing the second salt, or any combination thereof.

Clause 8. The method of any one of clauses 1-7, wherein the exothermic reaction occurs at a temperature of about 60° C. or greater, at a pH of about 5 or less, or any combination thereof.

Clause 9. The method of any one of clauses 1-8, wherein the first salt comprises a nitrite anion and the second salt comprises an ammonium cation, the nitrite anion and the ammonium cation undergoing the exothermic reaction once the first salt and the second salt are contacted with one another in the subterranean reservoir.

Clause 10. The method of any one of clauses 1-9, wherein the first salt comprises an alkali metal nitrite and the second salt comprises an ammonium halide.

Clause 11. The method of any one of clauses 1-10, wherein first salt comprises sodium nitrite and the second salt comprises ammonium chloride.

Clause 12. The method of any one of clauses 1-11, wherein the gellable fluid has a viscosity of about 0.1 cP to about 10 cP prior to heating.

Clause 13. The method of any one of clauses 1-12, wherein the gelled fluid has a viscosity of about 10 cP to about 25 cP after heating.

Clause 14. The method of any one of clauses 1-13, wherein the heating to form the gelled fluid increases the viscosity of the gelled fluid by about 100% or more relative to the gellable fluid.

Clause 15. The method of any one of clauses 1-14, further comprising: introducing an aqueous flooding fluid into the subterranean reservoir after heating the gellable fluid to form the gelled fluid, wherein the gelled fluid diverts the aqueous flooding fluid away from at least one blocking zone within the subterranean reservoir.

Clause 16. The method of clause 15, wherein the at least one blocking zone comprises a high permeability zone within the subterranean reservoir.

Clause 17. The method of any one of clauses 1-16, further comprising: producing hydrocarbons from the subterranean reservoir.

Clause 18. The method of any one of clauses 1-17, wherein the gellable starch has a concentration of about 0.1 wt % to about 2.5 wt % in the gellable fluid.

Clause 19. The method of any one of clauses 1-18, wherein the gellable starch comprises Cycas revoluta starch.

Clause 20. A method comprising: introducing a gellable fluid to a subterranean reservoir, the gellable fluid comprising Cycas revoluta starch dispersed in an aqueous fluid; introducing a first salt and a second salt into the subterranean reservoir, the first salt being capable of undergoing an exothermic reaction with the second salt; wherein the subterranean reservoir has a temperature insufficient to initiate the exothermic reaction between the first salt and the second salt; introducing an acid into the subterranean reservoir to initiate the exothermic reaction; contacting the first salt with the second salt in the subterranean reservoir in the presence of the acid to initiate the exothermic reaction; and heating the gellable fluid with heat produced from the exothermic reaction to form a gelled fluid comprising a gelled starch and having an increased viscosity.

Clause 21. The method of clause 20, wherein the acid is present in at least one of a first solution containing the first salt, a second solution containing the second salt, or any combination thereof.

Clause 22. The method of clause 20, wherein the first salt and the second salt are present in a first solution, and the acid is present in a second solution introduced to the subterranean reservoir separately from the first solution.

Clause 23. The method of any one of clauses 20-22, wherein the first salt comprises a nitrite anion and the second salt comprises an ammonium cation, the nitrite anion and the ammonium cation undergoing the exothermic reaction once the first salt and the second salt are contacted with one another in the subterranean reservoir.

Clause 24. A method comprising: introducing a gellable fluid to a subterranean reservoir, the gellable fluid comprising Cycas revoluta starch dispersed in an aqueous fluid; introducing a first salt solution comprising a first salt and a second salt solution comprising a second salt into the subterranean reservoir, the first salt being capable of undergoing an exothermic reaction with the second salt; contacting the first salt solution with the second salt solution in the subterranean reservoir under conditions where the first salt and the second salt undergo the exothermic reaction; and heating the gellable fluid with heat produced from the exothermic reaction to form a gelled fluid comprising a gelled starch and having an increased viscosity.

Clause 25. The method of clause 24, wherein the first salt solution and the second salt solution are kept separate from one another prior to contacting the first salt solution with the second salt solution in the subterranean reservoir.

Clause 26. The method of clause 24 or clause 25, wherein the first salt comprises a nitrite anion and the second salt comprises an ammonium cation, the nitrite anion and the ammonium cation undergoing the exothermic reaction once the first salt and the second salt are contacted with one another in the subterranean reservoir.

### EXAMPLES

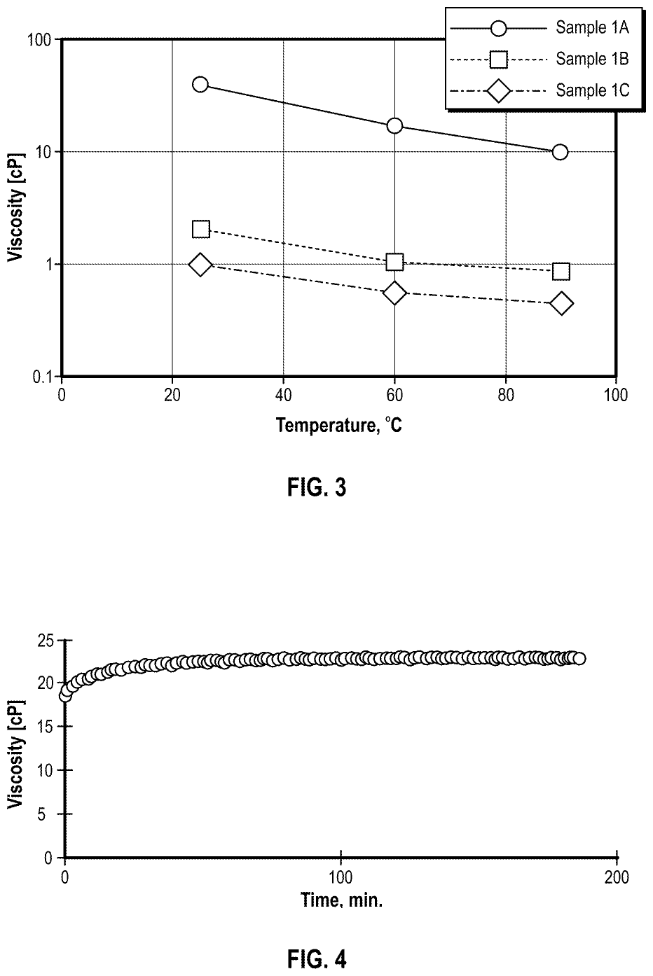

Samples 1A, 1B, and 1C were prepared in 57,000 ppm high-salinity brine containing Cycas revoluta starch at concentrations of 0.1 wt %, 1.0 wt %, and 2.5 wt %, respectively. Viscosity was measured according to ASTM D445 for each sample at varying temperatures. FIG. 3 is a graph of initial viscosity versus temperature for Samples 1A-1C. As shown, higher starch concentrations yielded higher viscosity values.

Sample 1D comprising Cycas revoluta starch at 0.25 wt % in the same high-salinity brine as above was prepared, The viscosity of Sample 1D was tested (ASTM D445) over a period of about 180 minutes at a temperature of about 90° C. FIG. 4 is a graph of viscosity versus time for Sample 1D at 90° C. As shown, the viscosity increased with time, which is indicative of gelling of the starch.

Samples 2A, 2B, and 2C comprising Cycas revoluta starch at 0.2 wt % in the same high-salinity brine as above were separately maintained for 1.5 hours at about 25° C. (Sample 2A), about 60° C. (Sample 2B), and about 90° C. (Sample 2C). The Cycas revoluta starch was visibly insoluble at the lower temperature, partially soluble at the intermediate temperature, and fully dispersed as a cloudy fluid at the highest temperature.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
introducing a gellable fluid to a subterranean reservoir, the gellable fluid comprising a gellable starch dispersed in an aqueous fluid;
introducing a first salt and a second salt into the subterranean reservoir, the first salt being capable of undergoing an exothermic reaction with the second salt;
contacting the first salt with the second salt in the subterranean reservoir under conditions where the first salt and the second salt undergo the exothermic reaction; and
heating the gellable fluid with heat produced from the exothermic reaction to form a gelled fluid comprising a gelled starch and having an increased viscosity.

2. The method of claim 1, wherein the gellable fluid is introduced to at least one blocking zone of the subterranean reservoir.

3. The method of claim 1, wherein the first salt is introduced to the subterranean reservoir in a first salt solution and the second salt is introduced to the subterranean reservoir in a second salt solution, the first salt solution and the second salt solution being kept separate from one another prior to contacting the first salt with the second salt in the subterranean reservoir.

4. The method of claim 1, wherein the first salt is introduced to the subterranean reservoir within the gellable fluid and the second salt is introduced to the subterranean reservoir in a second salt solution, the gellable fluid and the second salt solution being kept separate from one another prior to contacting the first salt with the second salt in the subterranean reservoir.

5. The method of claim 1, wherein the subterranean reservoir has a temperature sufficient to initiate the exothermic reaction, an acid is introduced to the subterranean reservoir to initiate the exothermic reaction, or any combination thereof.

6. The method of claim 5, wherein the acid is introduced to the subterranean reservoir to initiate the exothermic reaction, and the acid comprises an organic acid.

7. The method of claim 5, wherein the acid is introduced to the subterranean reservoir to initiate the exothermic reaction, and the acid is present in at least one of a first salt solution containing the first salt, a second salt solution containing the second salt, or any combination thereof.

8. The method of claim 1, wherein the exothermic reaction occurs at a temperature of about 60° C. or greater, at a pH of about 5 or less, or any combination thereof.

9. The method of claim 1, wherein the first salt comprises a nitrite anion and the second salt comprises an ammonium cation, the nitrite anion and the ammonium cation undergoing the exothermic reaction once the first salt and the second salt are contacted with one another in the subterranean reservoir.

10. The method of claim 1, wherein the first salt comprises an alkali metal nitrite and the second salt comprises an ammonium halide.

11. The method of claim 1, wherein first salt comprises sodium nitrite and the second salt comprises ammonium chloride.

12. The method of claim 1, wherein the gellable fluid has a viscosity of about 0.1 cP to about 10 cP prior to heating.

13. The method of claim 1, wherein the gelled fluid has a viscosity of about 10 cP to about 25 cP after heating.

14. The method of claim 1, wherein the heating to form the gelled fluid increases the viscosity of the gelled fluid by about 100% or more relative to the gellable fluid.

15. The method of claim 1, further comprising:
introducing an aqueous flooding fluid into the subterranean reservoir after heating the gellable fluid to form the gelled fluid, wherein the gelled fluid diverts the aqueous flooding fluid away from at least one blocking zone within the subterranean reservoir.

16. The method of claim 15, wherein the at least one blocking zone comprises a high permeability zone within the subterranean reservoir.

17. The method of claim 1, further comprising:
producing hydrocarbons from the subterranean reservoir.

18. The method of claim 1, wherein the gellable starch has a concentration of about 0.1 wt % to about 2.5 wt % in the gellable fluid.

19. The method of claim 1, wherein the gellable starch comprises Cycas revoluta starch.

20. A method comprising:
introducing a gellable fluid to a subterranean reservoir, the gellable fluid comprising Cycas revoluta starch dispersed in an aqueous fluid;
introducing a first salt and a second salt into the subterranean reservoir, the first salt being capable of undergoing an exothermic reaction with the second salt;
wherein the subterranean reservoir has a temperature insufficient to initiate the exothermic reaction between the first salt and the second salt;
introducing an acid into the subterranean reservoir to initiate the exothermic reaction;
contacting the first salt with the second salt in the subterranean reservoir in the presence of the acid to initiate the exothermic reaction; and
heating the gellable fluid with heat produced from the exothermic reaction to form a gelled fluid comprising a gelled starch and having an increased viscosity.

21. The method of claim 20, wherein the acid is present in at least one of a first solution containing the first salt, a second solution containing the second salt, or any combination thereof.

22. The method of claim 20, wherein the first salt and the second salt are present in a first solution, and the acid is present in a second solution introduced to the subterranean reservoir separately from the first solution.

23. The method of claim 20, wherein the first salt comprises a nitrite anion and the second salt comprises an ammonium cation, the nitrite anion and the ammonium cation undergoing the exothermic reaction once the first salt and the second salt are contacted with one another in the subterranean reservoir.

24. A method comprising:
introducing a gellable fluid to a subterranean reservoir, the gellable fluid comprising Cycas revoluta starch dispersed in an aqueous fluid;
introducing a first salt solution comprising a first salt and a second salt solution comprising a second salt into the subterranean reservoir, the first salt being capable of undergoing an exothermic reaction with the second salt;
contacting the first salt solution with the second salt solution in the subterranean reservoir under conditions where the first salt and the second salt undergo the exothermic reaction; and
heating the gellable fluid with heat produced from the exothermic reaction to form a gelled fluid comprising a gelled starch and having an increased viscosity.

25. The method of claim 24, wherein the first salt solution and the second salt solution are kept separate from one another prior to contacting the first salt solution with the second salt solution in the subterranean reservoir.

26. The method of claim 24, wherein the first salt comprises a nitrite anion and the second salt comprises an ammonium cation, the nitrite anion and the ammonium cation undergoing the exothermic reaction once the first salt and the second salt are contacted with one another in the subterranean reservoir.
